(19) United States
(12) Patent Application Publication
(10) Pub. No.: US 2026/0284810 A1
(43) Pub. Date: Sep. 24, 2026

(54) SHEET METAL BLANKS WITH REINFORCED AREAS

(71) Applicant: MAGNA INTERNATIONAL INC., Aurora, Ontario (CA)

(72) Inventors: Stephan KAUFHOLD, Sailauf, Bavaria (DE); Michael BLUEMEL, Weikersdorf (AT)

(21) Appl. No.: 19/474,224

(22) PCT Filed: Apr. 10, 2024
(86) PCT No.: PCT/CA2024/050451

§ 371 Date: Oct. 10, 2025

Related U.S. Application Data
(60) Provisional application No. 63/458,554, filed on Apr. 11, 2023.

(51) Int. Cl. B23P 17/04; B33Y 80/00

(52) U.S. Cl. CPC B23P 17/04; B33Y 80/00

(57) ABSTRACT

A method of manufacturing a reinforced steel or aluminum part, such as a part for a vehicle, from a reinforced blank is provided. The method includes forming a reinforcement patch and joining the reinforcement patch to a base by an additive manufacturing process to form a reinforced blank. After the additive manufacturing process, the method can include forming the reinforced blank by cold forming, warm forming, or hot forming. The full surface of the reinforcement patch bonds to the base, which provides performance benefits compared to welded reinforcement patches.

### CROSS-REFERENCE TO RELATED APPLICATIONS

This PCT International Patent Application claims the benefit of and priority to U.S. Provisional Patent Application Ser. No. 63/458,554, filed Apr. 11, 2023, titled “Sheet Metal Blanks With Reinforced Areas,” the entire disclosure of which is hereby incorporated by reference in its entirety.

### BACKGROUND OF THE INVENTION

### 1. Field of the Invention

The present invention relates to a blank with a reinforcement patch, a method of manufacturing the blank with the reinforcement patch, a part formed from the blank including the reinforcement patch, such as a part for use in a vehicle, and a method of manufacturing the part from the blank with the reinforcement patch.

### 2. Related Art

This section provides background information related to the present disclosure which is not necessarily prior art.

Parts formed from steel or aluminum-based material are often desired for use in vehicles. The parts are often formed from a blank, which is provided by a sheet of metal. The method of manufacturing the part can include cold, warm, or hot forming the blank to achieve a desired shape. The warm and hot forming processes typically include heating the blank in a furnace, and then transferring the heated blank to a forming device, such as a stamping press. The warm forming process typically includes forming an aluminum blank in a die while the aluminum blank is at a temperature ranging from 170° C. to 230° C. The hot forming process typically includes forming an aluminum blank in the die while the blank is at a temperature ranging from 400° C. to 500° C., or forming a steel blank in the die while the blank is at a temperature ranging from 950° C. to 1250° C. followed by quenching the hot formed part in the die.

Oftentimes, the steel or aluminum parts, such as those for use in vehicles, require tailored properties. For example, the parts may require higher strength or higher ductility in certain areas than others. One technique used to achieve the tailored properties includes joining a reinforcement patch to the blank in an area that requires the additional strength, for example by welding the reinforcement patch to the blank. However, other methods and techniques for achieving the tailored properties are desired.

### SUMMARY

This section provides a general summary of the disclosure and is not to be interpreted as a complete and comprehensive listing of all of the objects, aspects, features and advantages associated with the present disclosure.

One aspect of the subject disclosure provides a method of manufacturing a reinforced blank formed of steel or aluminum-based material. The method includes forming a reinforcement patch of steel or aluminum-based material and joining the reinforcement patch to a base formed of steel or aluminum-based material. The forming and joining steps include additive manufacturing.

Another aspect of the disclosure provides a reinforced blank. The reinforced blank includes a reinforcement patch formed of steel or aluminum-based material joined to a base of steel or aluminum-based material.

Another aspect of the disclosure provides a method of manufacturing a reinforced part. The method includes forming a reinforcement patch of steel or aluminum-based material and joining the reinforcement patch to a base formed of steel or aluminum-based material to provide a reinforced blank followed by forming the reinforced blank. The forming and joining steps include additive manufacturing.

Another aspect of the disclosure provides a reinforced part. The reinforced part includes a reinforcement patch formed of steel or aluminum-based material joined to a base formed of steel or aluminum-based material.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1-6 show examples of reinforced blanks each including at least one reinforcement patch joined to a base, wherein the at least one reinforcement patch is formed and joined to the base by an additive manufacturing process;

FIG. 7 is a comparative example of a reinforced blank including a reinforcement patch welded to a base;

FIGS. 8 and 9 show examples of additive manufacturing processes which include forming a reinforcement patch on a base; and

FIGS. 10A-10I show examples of reinforced parts that can be formed from a reinforced blank.

### DETAILED DESCRIPTION OF THE EXAMPLE EMBODIMENTS

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

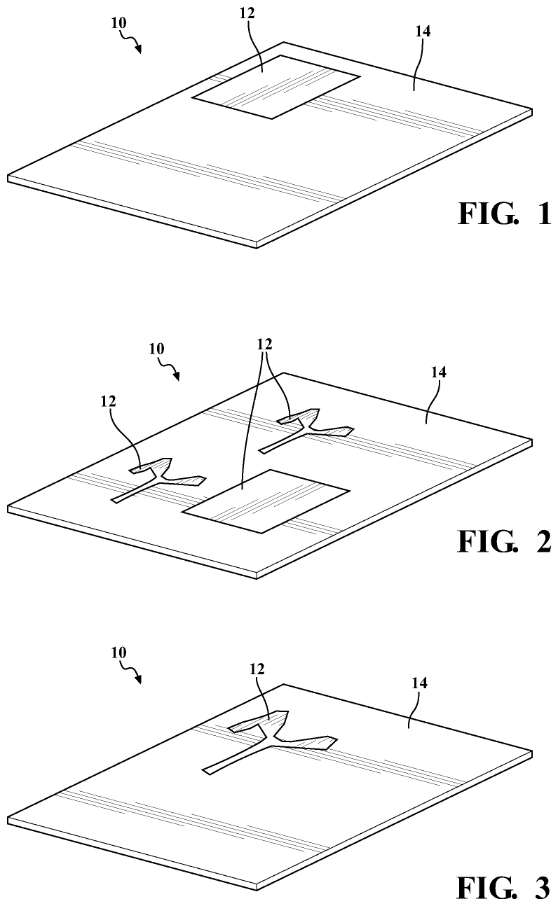

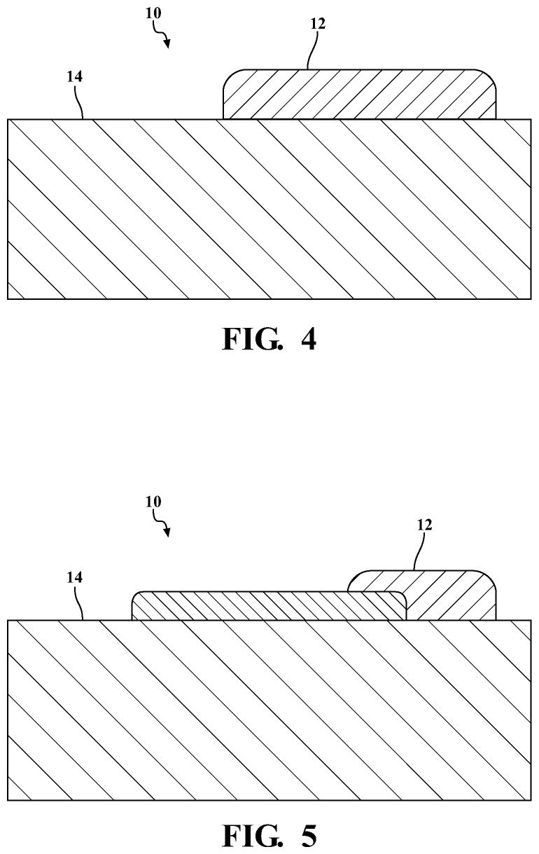

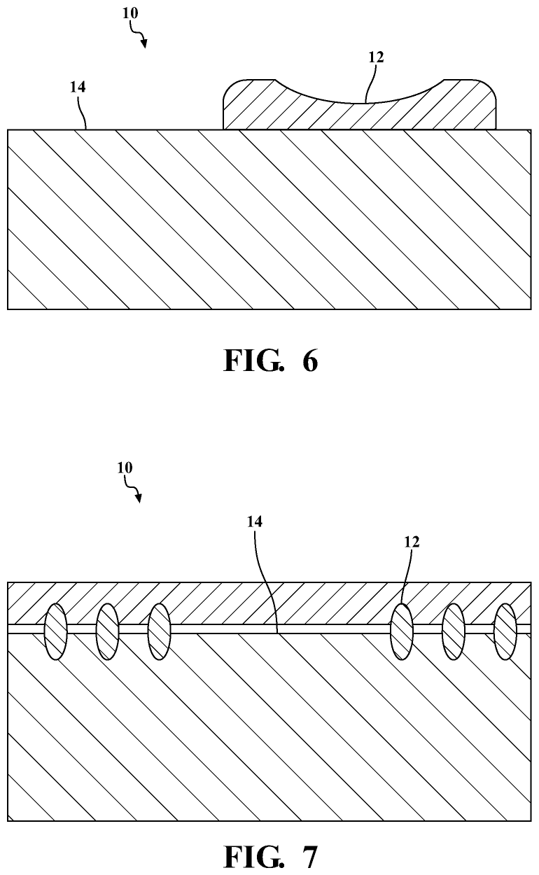

One aspect of the subject disclosure provides a method of manufacturing a reinforced blank 10 formed of steel or aluminum-based material. The reinforced blank 10 includes a reinforcement patch 12 joined to a base 14 which are both formed of steel or both formed of aluminum-based material. The composition of the material used to form the reinforcement patch 12 can be the same as or different from the material used to join the base 14. The reinforced blank 10 has tailored properties, for example additional strength in select areas. Examples of the reinforced blank 10 including the reinforcement patch 12 joined to the base 14 are shown in FIGS. 1-6.

According to one embodiment, the reinforcement patch 12 and the base 14 are both formed of steel. The steel of the reinforcement patch 12 can be the same as or different from the steel of the base 14. Alternatively, another iron-based material could be used for the reinforcement patch 12 and/or the base 14. According to an example embodiment, the reinforcement patch 12 and/or the base 14 are formed of high strength steel, for example steel having a strength of 1000 Mpa to 2000 Mpa. According to another example embodiment, the reinforcement patch 12 and/or the base 14 are formed of ductile, lower strength steel, for example steel having a strength of 400 Mpa to 1000 Mpa. According to yet another embodiment, the reinforcement patch 12 and/or the base 14 are formed of stainless steel, or a steel having a chromium content that is higher than the chromium content of stainless steel. According to yet another embodiment, the reinforcement patch 12 and/or the base 14 are formed of press-hardened steel which does not require a coating.

According to another embodiment, the reinforcement patch 12 and the base 14 are both formed of aluminum-based material. The aluminum-based material of the reinforcement patch 12 can be the same as or different from the aluminum-based material of the base 14. Aluminum-based materials that can be used to form the reinforcement patch 12 and the base 14 include aluminum and aluminum alloys. According to example embodiments, the base 14 and/or the reinforcement patch 12 are formed of an aluminum alloy having a 5xxx, 6xxx, or 7xxxx grade.

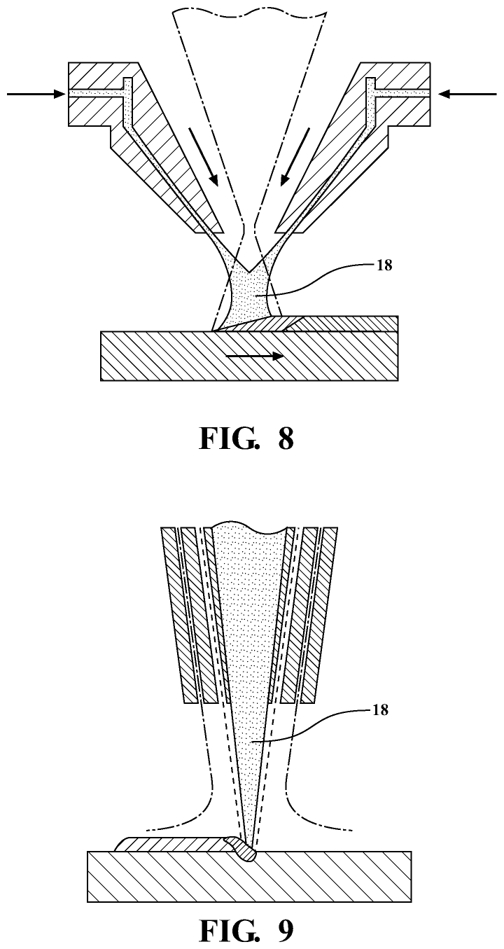

Both the forming of the reinforced blank 12 and the joining of the reinforcement patch 12 to the base 14 includes an additive manufacturing process. The additive manufacturing process forms the reinforcement patch 12 on the base 14 and causes the reinforcement patch 12 to bond to the base 14. The additive manufacturing process typically includes at least one of 3-D printing, laser cladding, cold spraying, laser metal deposition (LMD), powder bed fusion, laser welding with a wire, and binder jetting. A powder or wire formed of the steel or the aluminum-based material can be used to form the reinforcement patch 12. The additive manufacturing process naturally joins the reinforcement patch 12 to the base 14 to form the reinforced blank 10. The additive manufactured reinforcement patch 12 is thermally joined over the entire area of the reinforcement patch 12 (the additive manufactured zone). In other words, the reinforcement patch 12 presents a surface area facing the base 14, and an entirety of the surface area facing the base 14 is thermally bonded to the base 14. A reinforced blank 10 including a reinforcement patch 12 welded to the base 14 is shown in FIG. 7 for purposes of comparison. Examples of the additive manufacturing process which include forming the reinforcement patch 12 on the base 14 using a jet or stream of powder are shown in FIGS. 8 and 9.

The local areas of the reinforced blank 10 including the reinforcement patch 12 can have complex shapes and can also vary in thickness within the geometry of the patched area. In addition, the reinforced blank 10 can include a plural reinforcement patches 12 of the same shape or thickness, or of varying shape or thickness, which are formed by the additive manufacturing process. Due to the flexibility of the additive manufacturing process, the shape of the reinforcement patch 12 and the thickness of the reinforcement patch 12 can vary greatly according to performance needs. The reinforcement patch 12 of the reinforced blank 10 typically has a thickness ranging from 0.1 millimeters (mm) to 4.0 mm. The base 14 of the reinforced blank 100 typically has a thickness ranging from 0.7 mm to 4.0 mm. Further, the thickness can vary throughout the reinforcement patch 12.

The fully bonded surface of the reinforcement patch 12 to the base 14 manufactured by the additive manufacturing process offers many advantages in performance over welded reinforcement patches. The bonded reinforcement patch 12 can provide performance improvements. For example, the reinforcement patch 12 can withstand higher loads in a crash than traditional spot-welded patches. The spot-welded patches are only local joined along the weld spots. The additive manufactured reinforcement patch 12, however, is joined over the entire area of the reinforcement patch 12.

In addition, the placement of the spot welds on the traditional patch may be limited. For example, a shear load that occurs during a hot stamping processing may limit the placement of the traditional spot-welded patch. If the shear load exceeds a certain limit, the spot weld could be torn out and thus fail during the forming process. In cases where these spot welds are necessary, the spot welds must be added after the hot stamping process, which adds an extra process step and cost.

After forming and joining the reinforcement patch 12 to the base 14 by the additive manufacturing process to form the reinforced blank 10, the method of manufacturing the reinforced part 16 can include cold forming, warm forming or hot forming the reinforced blank 10 with the reinforcement patch 12. Alternatively, the base 14 could be formed prior to the additive manufacturing process.

The warm forming process is typically conducted on reinforced blanks 10 formed of aluminum-based material, rather than the steel. The warm forming process typically includes heating the reinforced blank 10 in a furnace, and then transferring the heated reinforced blank 10 to a forming device, such as a stamping press. The warm forming process typically includes forming the reinforced blank 10 in a die while the reinforced blank 10 is at a temperature ranging from 170° C. to 230° C.

The hot forming process can be conducted on reinforced blanks 10 formed of steel or aluminum-based material. The hot forming process typically includes heating the reinforced blank 10 in a furnace, and then transferring the heated reinforced blank 10 to a forming device, such as a stamping press. When the reinforced blank is formed of steel, the hot forming process typically includes forming the reinforced blank 10 in the die while the reinforced blank 10 is at a temperature ranging from 950° C. to 1250° C. to form the hot formed reinforced part 16, followed by quenching the hot formed part 16 in the die. When the reinforced blank is formed of aluminum-based material, the hot forming process typically includes forming the reinforced blank 10 in the die while the reinforced blank 10 is at a temperature ranging from 400° C. to 500° C. to form the hot formed reinforced part 16, followed by quenching the hot formed part 16 in the die. According to example embodiments, the step of heating the reinforced blank 10 is convection heating or jet heating. The reinforcement patch 12 can be hardened during the hot stamping process, or the reinforcement patch 12 can maintain its hardness and ductility during the hot stamping process.

The method of manufacturing the reinforced part 16 can also include pre-heating a portion of the reinforced blank 10 including the reinforcement patch 12 prior to heating the entire reinforced blank 10 in the furnace. For example, the reinforced area can be pre-heated prior to heating the entire reinforced blank 10 in a main roller hearth furnace to ensure homogeneous heating of the entire reinforced blank 10 and an optimum cycle time. The method can also include post-heating the portion of the reinforced blank 10 including the reinforcement patch 12 after heating the entire reinforced blank 10 in the main furnace to ensure homogeneous heating of the entire reinforced blank 10 and an optimum cycle time.

According to an example embodiment, the reinforcement patch 12 or the entire reinforced blank 10 can be coated with a heat absorbing coating, prior to heating, which will enhance and improve heat absorption during the heating steps. For example a heat resistant coating which is dark in color can be applied to the reinforcement patch 12 to allow for homogeneous heating of the entire reinforced blank 10. Alternatively, the reinforcement patch 12 can be engineered to have a structure or surface condition that will absorb heat faster than the base 14 of the reinforced blank 10 to allow for homogeneous heating of the entire reinforced blank 10. When the reinforced blank is formed of steel, the reinforcement patch 12 and/or the base 14 can be coated with AlSi, ZnFe or other coatings, or the reinforced blank 10 can remain uncoated. After hot stamping and quenching the reinforced blank 10 formed of steel, a coating formed of zinc can be applied to the reinforcement patch 12 and/or the base 14 to provide adequate corrosion resistance. The zinc coating can be applied by electro galvanizing have a thickness ranging from 1 micron up to 30 microns.

The forming device used to form the reinforced blank 10 can be a stamping or pressing tool which includes a die that is designed to accommodate the shape of the reinforced blank 10 with the reinforced patch 12. When the process includes hot stamping, the cooling in the area of the reinforcement patch 12 is adjusted to adequately cool and quench the area containing the reinforcement patch 12 and achieve an optimum cycle time. After forming the reinforced blank 10, the method can include additional processing of the reinforced blank 10, such as laser cutting.

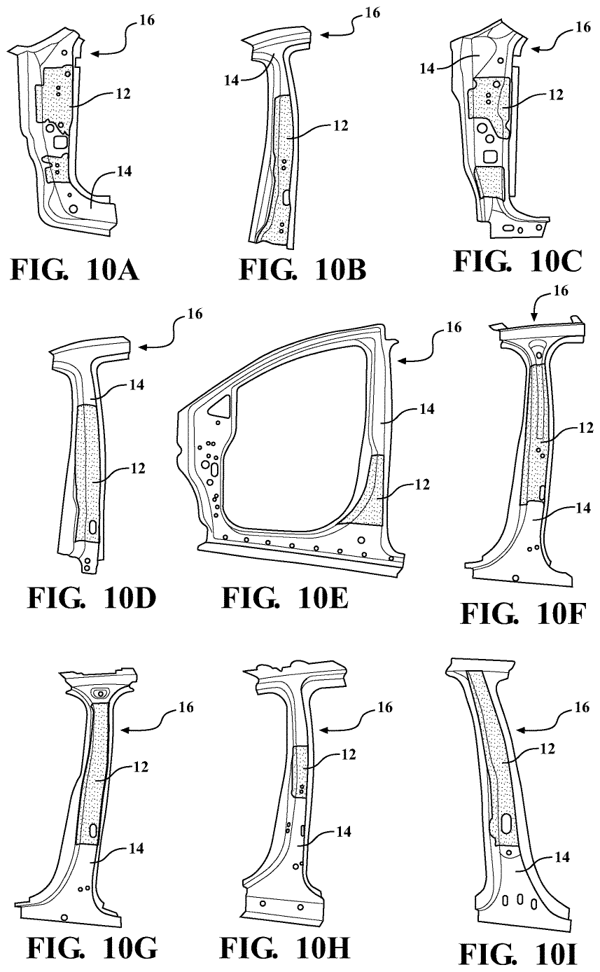

The reinforced blank 10 can be used to manufacture various types of the reinforced parts 16, such as those for use in vehicle applications. Parts 16 formed from the reinforced blank 10 can be used to form a body structure of a vehicle, for example an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, and tunnel reinforcement. Parts 16 formed from the reinforced blank 10 can also be used as components of battery electric vehicles (BEV) and electric vehicles (EV), for example a side member of a battery tray, cross member of a battery tray, reinforcement of a battery tray, corner reinforcement, battery tray cover, and battery tray cover reinforcement. Examples of reinforced parts 16 that can be formed from the reinforced blank 10 described herein are shown in FIGS. 10A-10I.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A method of manufacturing a reinforced blank, comprising the steps of:
forming a reinforcement patch of an iron-based material or aluminum-based material; and
joining the reinforcement patch to a base of steel or aluminum-based material;
the forming and joining steps including additive manufacturing.

2. The method of claim 1, wherein the reinforcement patch and the base are formed of steel.

3. The method of claim 2, wherein the steel is selected from the group consisting of steel having a strength of 1000 Mpa to 2000 Mpa; steel having a strength of 400 Mpa to 1000 Mpa; stainless steel; steel having a chromium content higher than a chromium content of stainless steel; and press-hardened steel.

4. The method of claim 1, wherein the reinforcement patch and the base are formed of an aluminum alloy having a 5xxx, 6xxx, or 7xxxx grade.

5. The method of claim 1, wherein the additive manufacturing step includes at least one of 3-D printing, laser cladding, cold spraying, laser metal deposition (LMD), powder bed fusion, laser welding with a wire, and binder jetting.

6. The method of claim 5, wherein a powder or wire formed of the steel, iron-based material, or aluminum-based material is used to form the reinforcement patch.

7. The method of claim 1, wherein the reinforcement patch presents a surface area facing the base, and an entirety of the surface area facing the base is thermally bonded to the base.

8. The method of claim 1, wherein the reinforcement patch has a thickness ranging from 0.7 mm to 4.0 mm.

9. The method of claim 1, wherein the reinforcement patch varying throughout the reinforcement patch.

10. A reinforced blank, comprising a reinforcement patch formed of steel, iron-based material, or aluminum-based material joined to a base formed of steel, iron-based material, or aluminum-based material according to the method of claim 1.

11. A method of manufacturing a reinforced part, comprising the steps of:
forming a reinforcement patch of steel, iron-based material, or aluminum-based material;
joining the reinforcement patch to a base of steel, iron-based material, or aluminum-based material to form a reinforced blank; and
the forming and joining steps including additive manufacturing.

12. The method of claim 11 including forming the base to a desired shape prior to the additive manufacturing.

13. The method of claim 11 further including forming the reinforced blank to a desired shape after the additive manufacturing.

14. The method of claim 13, wherein the step of forming the reinforced blank includes cold forming, warm forming, or hot forming.

15. The method of claim 14, wherein the step of forming the reinforced blank includes warm forming or hot forming, and further including pre-heating a portion of the reinforced blank including the reinforcement patch prior to the warm forming or the hot forming of the reinforced blank.

16. The method of claim 14, wherein the step of forming the reinforced blank includes warm forming, and the warm forming includes heating the reinforced blank in a furnace, transferring the heated reinforced blank to a stamping press containing a die, and forming the reinforced blank in the die while the reinforced blank is at a temperature ranging from 170° C. to 230° C.

17. The method of claim 14, wherein the step of forming the reinforced blank includes hot forming, the hot forming includes heating the reinforced blank in a furnace, transferring the heated reinforced blank to a stamping press containing a die, forming the reinforced blank in the die while the reinforced blank is at a temperature ranging from 950° C. to 1250° C. if the reinforced blank is formed of steel or an iron-based material or at a temperature ranging from 400° C. to 500° C. if the reinforced blank is formed of an aluminum-based material, and quenching the reinforced blank in the die after the forming step.

18. The method of claim 14 including coating the reinforcement patch with a heat absorbing coating prior to the step of forming the reinforced blank, and the step of forming the reinforced blank includes warm forming or hot forming.

19. A reinforced part, comprising:
a reinforcement patch formed of steel, iron-based material, or aluminum-based material joined to a base formed of steel, iron-based material, or aluminum-based material;
the reinforcement patch presenting a surface area facing the base; and
an entirety of the surface area facing the base being thermally bonded to the base.

20. The reinforced part of claim 19, wherein the reinforced part has the shape of an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, tunnel reinforcement, side member of a battery tray, cross member of a battery tray, reinforcement of a battery tray, corner reinforcement, battery tray cover, or battery tray cover reinforcement.
